(19) United States
(12) Patent Application Publication
(10) Pub. No.: US 2018/0284800 A1
(43) Pub. Date: Oct. 4, 2018

(54) ELECTRONIC DEVICE AND ROUTE SEARCHING METHOD THEREFOR

(71) Applicants: Fu Tai Hua Industry (Shenzhen) Co., Ltd., Shenzhen (CN); HON HAI PRECISION INDUSTRY CO., LTD., New Taipei (TW)

(72) Inventors: SUO-BING SU, New Taipei (TW); XIAN QIAN, Shenzhen (CN); MING-JEN CHENG, New Taipei (TW); YU-CHING HSU, New Taipei (TW); DAN HE, Shenzhen (CN)

(21) Appl. No.: 15/826,838

(22) Filed: Nov. 30, 2017

(30) Foreign Application Priority Data
Apr. 1, 2017 (CN) 201710213649.5

(51) Int. Cl. G05D 1/02

(52) U.S. Cl. CPC G05D 1/0242; H04B 17/318; G05D 1/0225; G05D 1/028

(57) ABSTRACT

A route searching method used in an electronic device includes detecting decreased available power of the electronic device. When the available power of the electronic device is less than the predetermined value, determining whether a first communication device receives infrared signals transmitted by the charging device. If the infrared signals are not received, the electronic device is driven to repeatedly to continuously turn through a predetermined angle to find a moving orientation of the electronic device, driving the electronic device to move along the orientation, determining whether the first communication device receives the infrared signals transmitted by the charging device when the electronic device is moving, and driving the electronic device to move to the charging device under guidance of the infrared signals, when the first communication device receives the infrared signals transmitted by the charging device.

### CROSS-REFERENCE TO RELATED APPLICATIONS

This application claims priority to Chinese Patent Application No. 201710213649.5 filed on Apr. 1, 2017, the contents of which are incorporated by reference herein.

### FIELD

The subject matter herein generally relates to smart electronic devices, and particularly to an electronic device and a route searching method therefor.

### BACKGROUND

Smart household appliances, such as robot cleaners, can be guided in moving by infrared rays. However, a transmission distance of the infrared rays is relatively short. Thus, when the smart household appliances are far away from a base station, such as a charging device, the smart household appliances may not be able to return to the charging device for charging.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram illustrating an exemplary embodiment of an electronic device.

FIGS. 2-3 illustrate a flowchart of an exemplary embodiment of a route searching method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

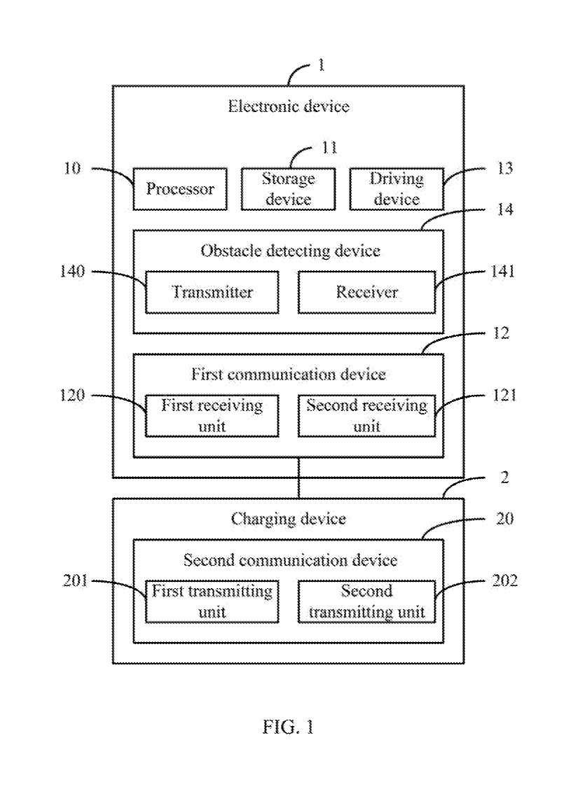

FIG. 1 illustrates an exemplary embodiment of an electronic device 1. The electronic device 1 includes, but is not limited to, a processor 10, a storage device 11, a first communication device 12, and a driving device 13. In at least one exemplary embodiment, the electronic device 1 can be a smart robot or other suitable household appliance, such as robot cleaner. FIG. 1 illustrates only one example of the electronic device 1, other examples can include more or fewer components than illustrated, or have a different configuration of the various components in other embodiments.

The electronic device 1 communicates with a charging device 2 through the first communication device 12. The charging device 2 includes a second communication device 20. The second communication device 20 includes a first transmission unit 201 and a second transmission unit 202. In at least one exemplary embodiment, the first transmission unit 201 can be an infrared sensor, which is used for transmitting infrared rays. The second transmission unit 202 can be a wireless communication module, such as a WI-FI module, which is used for transmitting radio signals.

In at least one exemplary embodiment, the first communication device 12 includes a first receiving unit 120 and a second receiving unit 121. The first receiving unit 120 can be an infrared sensor, which is used for receiving the infrared signals transmitted by the first transmission unit 201. The second receiving unit 121 can be a wireless communication module that can receive radio signals transmitted by the second transmission unit 202, such as a WI-FI module.

In at least one exemplary embodiment, the driving device 13 can be an electric motor. The electronic device 1 further includes a number of wheels (not shown) enabling the electronic device 1 to move towards all directions. The driving device 13 is used for driving the electronic device 1 to move. The motion of the electronic device 1 can include straight line and circling motions.

In at least one exemplary embodiment, the processor 10 can be a central processing unit (CPU), a microprocessor, or other data processor chip that performs functions of the electronic device 1.

In at least one exemplary embodiment, the storage device 11 can include various types of non-transitory computer-readable storage mediums. For example, the storage device 11 can be an internal storage system, such as a flash memory, a random access memory (RAM) for temporary storage of information, and/or a read-only memory (ROM) for permanent storage of information. The storage device 11 can also be an external storage system, such as a hard disk, a storage card, or a data storage medium.

The processor 10 detects whether available power of the electronic device 1 is less than a predetermined value. In at least one exemplary embodiment, the predetermined value can be a percentage of full charge, such as twenty percent of full charge.

When the available power of the electronic device 1 is less than the predetermined value, the processor 10 determines whether the first receiving unit 120 receives the infrared signals transmitted by the first transmission unit 201.

When the processor 10 determines that the first receiving unit 120 receives the infrared signals transmitted by the first transmission unit 201, this indicates that the electronic device 1 is in a radiating range of the infrared rays transmitted by the first transmission unit 201. At this time, the processor 10 can control the driving device 13 to drive the electronic device 1 to move to the charging device 2, under guidance of the infrared signals. Then the electronic device 1 can electrically couple to the charging device 2 for charging.

When the processor 10 determines that the first receiving unit 120 does not receive the infrared signals transmitted by the first transmission unit 201, the processor 10 uses the radio signals between the second transmitting unit and the second receiving unit to control the driving device 13 to drive the electronic device 1 to repeatedly turn through a predetermined angle. The processor 10 further controls the second receiving unit 121 to receive radio signals at every turn, and feeds any received radio signals back to the processor 10. In at least one exemplary embodiment, the predetermined angle is forty-five degrees. In other exemplary embodiments, the predetermined angle can be any other suitable value.

When a number of turns of the electronic device 1 reaches a predetermined value, the processor 10 compares signal strength of the received radio signals from each turn, determines the radio signal having the greatest signal strength, and determines an orientation of the electronic device 1 when receiving the radio signal having the greatest signal strength. In at least one exemplary embodiment, the predetermined value of number of turns is eight.

For example, when the electronic device 1 turns through the predetermined angle three times, the processor 10 determines an orientation of the electronic device 1 when receiving the radio signal having the greatest signal strength. In this example, the second receiving unit 121 receives the radio signal having the greatest signal strength when the electronic device 1 has turned through 135 degrees. Then the processor 10 controls the driving device 13 to drive the electronic device 1 to move along the orientation of the greatest signal strength, thus the driving device 13 can drive the electronic device 1 to enter or reenter the radiating range of the infrared rays under the guidance of the radio signals. In at least one exemplary embodiment, according to the foregoing ways, the electronic device 1 can determine a nearest route to move to the charging device 2.

When the electronic device 1 is moving, the processor 10 determines whether the first receiving unit 120 receives the infrared signals transmitted by the first transmission unit 201. If the processor 10 can determine that the first receiving unit 120 receives the infrared signals transmitted by the first transmission unit 201, the electronic device 1 is in the radiating range of the infrared rays transmitted by the first transmission unit 201. At this time, the processor 10 controls the driving device 13 to drive the electronic device 1 to move to the charging device 2, under the guidance of the infrared signals. Then the electronic device 1 can electrically couple to the charging device 2 for charging.

The electronic device 1 further includes an obstacle detecting device 14. The obstacle detecting device 14 is used for detecting whether at least one obstacle exists, within a predetermined distance on a moving route of the electronic device 1. In at least one exemplary embodiment, the predetermined distance is one meter. In other exemplary embodiments, the predetermined distance can be any other suitable value.

The obstacle detecting device 14 includes a transmitter 140 and a receiver 141. The transmitter 140 is used for transmitting a radio signal having a predetermined frequency. In at least one exemplary embodiment, the radio signal can be an ultrasonic wave signal, the predetermined frequency is different from frequency of the radio signals and the infrared signals transmitted by the second communication device 20. When the obstacle detecting device 14 determines that the receiver 141 receives a reflected signal having the same frequency, the obstacle detecting device 14 determines that at least one obstacle exists within the predetermined distance on the moving route of the electronic device 1.

When the obstacle detecting device 14 determines that no obstacle exists within the predetermined distance on the moving route of the electronic device 1, the processor 10 controls the driving device 13 to drive the electronic device 1 to move the predetermined distance, and the obstacle detecting device 14 continues to detects whether at least one obstacle exists within the predetermined distance on the moving path of the electronic device 1.

When the obstacle detecting device 14 determines that at least one obstacle exists within the predetermined distance on the moving route of the electronic device 1, the processor 10 controls the driving device 13 to drive the electronic device 1 to bypass the obstacle return to the determined orientation.

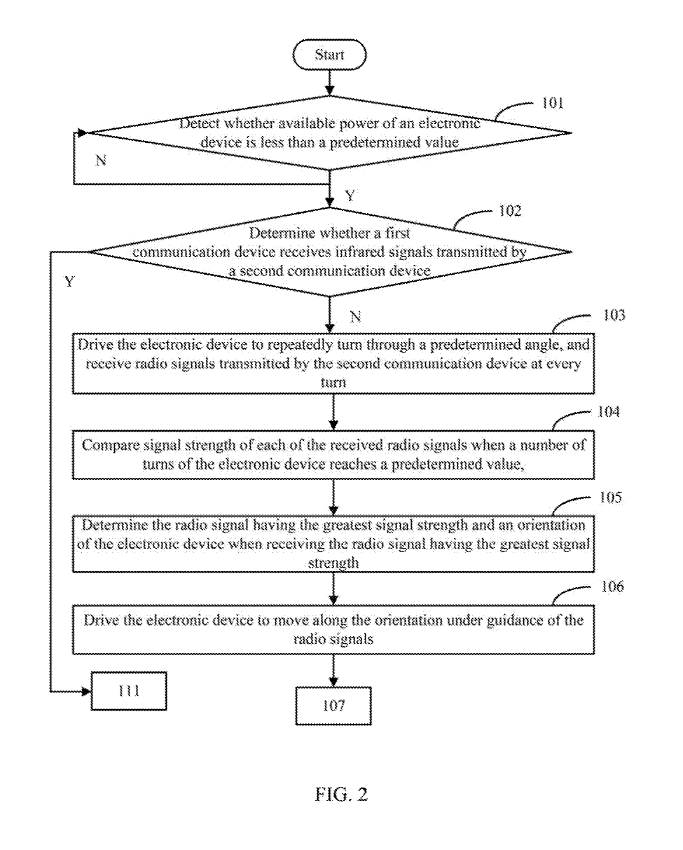

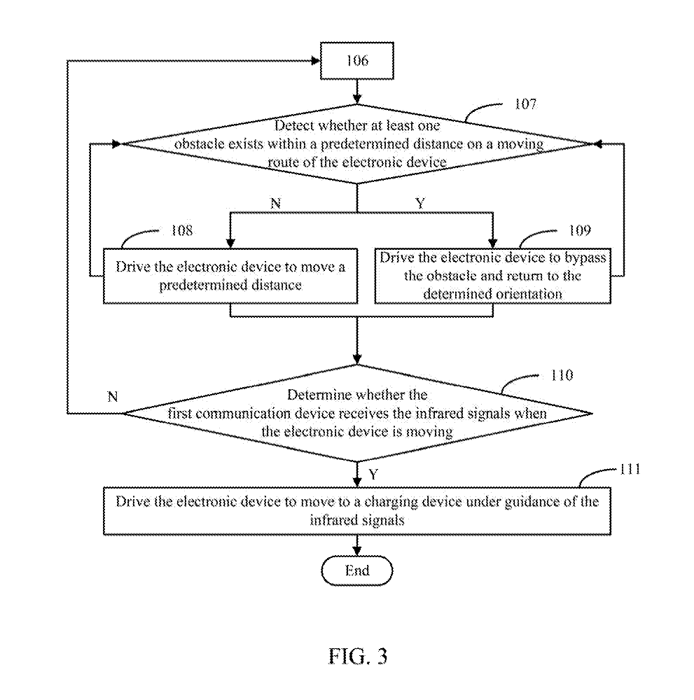

FIGS. 2-3 illustrate a flowchart of an exemplary embodiment of a route searching method. The method is provided by way of example, as there are a variety of ways to carry out the method. The method described below can be carried out using the configurations illustrated in FIG. 1, for example, and various elements of these figures are referenced in explaining the example method. Each block shown in FIGS. 2-3 represent one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 101.

At block 101, a processor detects whether the available power of an electronic device is less than a predetermined value. If the available power of the electronic device is less than a predetermined value, the process jumps to block 102. If the available power of the electronic device is not less than a predetermined value, the process remains in block 101.

At block 102, the processor determines whether a first communication device receives infrared signals transmitted by a second communication device. If the first communication device receives the infrared signals transmitted by the second communication device, the process jumps to block 111. If the first communication device does not receive the infrared signals transmitted by the second communication device, the process jumps to block 103.

At block 103, the processor controls a driving device to drive the electronic device to repeatedly turn through a predetermined angle, and receives radio signals transmitted by the second communication device at every turn.

At block 104, when a number of turns of the electronic device reaches a predetermined value, the processor compares signal strength of each of the received radio signals.

At block 105, the processor determines the radio signal having the greatest signal strength, and determines an orientation of the electronic device when receiving the radio signal having the greatest signal strength.

At block 106, the processor controls the driving device to drive the electronic device to move along the determined orientation under guidance of the radio signals.

At block 107, an obstacle detecting device detects whether at least one obstacle exists within a predetermined distance on a moving route of the electronic device. If at least one obstacle is found to exist within the predetermined distance on the moving route of the electronic device, the process jumps to block 108. If no obstacle is found to exist within the predetermined distance on the moving route of the electronic device 1, the process jumps to block 109.

At block 108, the processor controls the driving device to drive the electronic device to move a predetermined distance.

At block 109, the processor controls driving device to drive the electronic device to bypass the obstacle and return to the determined orientation.

At block 110, when the electronic device is moving, the processor determines whether the first communication device receives the infrared signals transmitted by the second communication device. If the first communication device receives the infrared signals transmitted by the second communication device, the process jumps to block 111. If the first communication device does not receive the infrared signals transmitted by the second communication device, the process returns to block 106.

At block 111, the processor controls the driving device to drive the electronic device to move to the charging device under guidance of the infrared signals.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
at least one processor;
a first communication device coupled to the at least one processor, wherein the electronic device communicates to a charging device through the first communication device;
a driving device coupled to the at least one processor; and
a storage device coupled to the at least one processor and storing instructions for execution by the at least one processor to cause the at least one processor to:
detect whether available power of the electronic device is less than a predetermined value;
determine, when the available power of the electronic device is less than the predetermined value, whether the first communication device receives infrared signals transmitted by the charging device;
control, when the first communication device does not receive the infrared signals transmitted by the charging device, the driving device to drive the electronic device to continuously turn through a predetermined angle;
determine an orientation of the electronic device;
control the driving device to drive the electronic device to move along the orientation;
continue to determine, when the electronic device is moving, whether the first communication device receives the infrared signals transmitted by the charging device; and
control, when the first communication device receives the infrared signals transmitted by the charging device, the driving device to drive the electronic device to move to the charging device, under guidance of the infrared signals.

2. The electronic device according to claim 1, wherein the at least one processor is further caused to:
control the first communication device to receive the radio signals at every turn;
compare, when a number of turns of the electronic device reaches a predetermined value, the signal strength of each of the received radio signals;
determine the radio signal having the greatest signal strength; and
determine an orientation of the electronic device when receiving the radio signal having the greatest signal strength.

3. The electronic device according to claim 2, wherein the predetermined angle is forty-five degrees and the predetermined value of number of turns is eight.

4. The electronic device according to claim 1, wherein the first communication device comprises a first receiving unit and a second receiving unit, the first receiving unit is used for receiving the infrared signals transmitted by the charging device. The second receiving unit is used for receiving the radio signals transmitted by the charging device.

5. The electronic device according to claim 4, wherein the charging device comprises a second communication device, the second communication device comprises a first transmission unit and a second transmission unit, the first transmission unit is used for transmitting infrared rays, the second transmission unit is used for transmitting radio signals, the first receiving unit is used for receiving the infrared signals transmitted by the first transmission unit. The second receiving unit is used for receiving the radio signals transmitted by the second transmission unit.

6. The electronic device according to claim 1, further comprising:
an obstacle detecting device used for detecting whether at least one obstacle exists, within a predetermined distance on a moving route of the electronic device.

7. The electronic device according to claim 6, wherein the at least one processor is further caused to:
control, when the obstacle detecting device determines that no obstacle exists within the predetermined distance on the moving route of the electronic device, the driving device to drive the electronic device to move a predetermined distance; and
control, when the obstacle detecting device determines that at least one obstacle exists within the predetermined distance on the moving route of the electronic device, the driving device to drive the electronic device to bypass the obstacle and move along the orientation.

8. The electronic device according to claim 6, wherein the obstacle detecting device comprises a transmitter and a receiver, the transmitter is used for transmitting a radio signal having a predetermined frequency, when the obstacle detecting device determines that the receiver receives a reflected signal having the same frequency, the obstacle detecting device determines that at least one obstacle exists within the predetermined distance on the moving route of the electronic device.

9. A route searching method comprising:
detecting whether available power of the electronic device is less than a predetermined value;
when the available power of the electronic device is less than the predetermined value, determining whether a first communication device receives infrared signals transmitted by a charging device;
when the first communication device does not receive the infrared signals transmitted by the charging device, driving the electronic device to continuously turn through a predetermined angle;
determining an orientation of the electronic device;
driving the electronic device to move along the orientation;
determining whether the first communication device receives the infrared signals transmitted by the charging device, when the electronic device is moving; and
when the first communication device receives the infrared signals transmitted by the charging device, driving the electronic device to move to the charging device under guidance of the infrared signals.

10. The method according to claim 9, wherein the step of determining an orientation of the electronic device comprises:
receiving the radio signals at every turn;
comparing signal strength of each of the received radio signals when a number of turns of the electronic device reaches a predetermined value;
determining the radio signal having the greatest signal strength; and
determining an orientation of the electronic device when receiving the radio signal having the greatest signal strength.

11. The method according to claim 10, wherein the predetermined angle is forty-five degrees and the predetermined value of number of turns is eight.

12. The method according to claim 9, further comprising:
detecting whether at least one obstacle exists within a predetermined distance on a moving route of the electronic device.

13. The method according to claim 12, further comprising:
driving the electronic device to move a predetermined distance, when no obstacle exists within the predetermined distance on the moving route of the electronic device; and
driving the electronic device to bypass the obstacle and move along the orientation, when at least one obstacle exists within the predetermined distance on the moving route of the electronic device.
